(19) United States
(12) Patent Application Publication
(10) Pub. No.: US 2022/0382062 A1
(43) Pub. Date: Dec. 1, 2022

(54) HEAD MOUNTED DISPLAYS WITH AN ADJUSTABLE LAYER

(71) Applicant: HEWLETT-PACKARD DEVELOPMENT COMPANY, L.P., Spring, TX (US)

(72) Inventor: Chiao-Ting Cheng, Taipei City (TW)

(21) Appl. No.: 17/333,663

(22) Filed: May 28, 2021

(51) Int. Cl. G02B 27/01; G02B 27/00; G06K 9/00

(52) U.S. Cl. CPC G02B 27/0176; G02B 27/0093; G06K 9/00248; G02B 2027/0178; G02B 2027/0154

(57) ABSTRACT

In example implementations, an apparatus is provided. The apparatus includes an eye mount, an adjustable layer, and a foam layer. A first side of the eye mount is to be coupled to a display portion of a head mounted display. The adjustable layer is coupled to an outer perimeter of a second side of the eye mount. The foam layer is coupled to the adjustable layer.

### BACKGROUND

Virtual reality devices are becoming ubiquitous. Virtual reality devices include various components that allow a user to consume virtual reality applications, such as video games. The virtual reality devices may include head mounted displays, hand held controllers, wearable sensors, and the like. A head mounted display may be worn on or over the face of the user. The hand held controllers may allow the user to interact with objects in the applications shown on the head mounted display.

### BRIEF DESCRIPTION OF THE DRAWINGS

FIG. 1 is a block diagram of an example virtual reality (VR) system of the present disclosure;

FIG. 2 is a block diagram of a portion of an example head mounted display (HMD) with adjustable eye relief of the present disclosure;

FIG. 3 is a block diagram of a bottom view of a portion of the example HMD with adjustable eye relief of the present disclosure;

FIG. 4 is a block diagram of an air bag system that provides adjustable eye relief for the HMD of the present disclosure;

FIG. 5 is a block diagram of another example portion of an HMD with adjustable eye relief of the present disclosure;

FIG. 6 is a block diagram of an air bag system with independently inflatable sections that provide adjustable eye relief for the HMD of the present disclosure;

FIG. 7 is a block diagram of another example portion of an HMD with adjustable eye relief of the present disclosure; and

FIG. 8 is a flow chart of an example method to adjust eye relief of an HMD of the present disclosure.

### DETAILED DESCRIPTION

Examples described herein provide a head mounted display (HMD) with adjustable eye relief, and a method for adjusting eye relief of the HMD. As discussed above, virtual reality devices include various components that allow a user to consume virtual reality applications, such as video games. The virtual reality devices may include HMDs, hand held controllers, wearable sensors, and the like. An HMD may be worn on or over the face of the user.

One-size-fits-all HMDs may create fitting issues for different users. For example, users without glasses may want a wider field of view (FOV). As a result, an HMD may be sized to create the smallest distance between a user's eye and the display in the HMD. However, some users who wear glasses may experience discomfort when wearing HMDs that are sized to provide a minimum eye relief.

Furthermore, different users have differently shaped contours around their eyes and faces. Thus, an HMD may not fit perfectly around the face of a user. This may create gaps at some points on the user's face when wearing the HMD. These gaps may cause light to enter the HMD, which may in turn cause image quality issues or create distractions for the user while interacting with the virtual reality system.

Moreover, the HMD may not fit comfortably for the user. For example, some portions of the HMD may press more firmly against the user's face than other portions to eliminate gaps. This may lead to discomfort over long periods of use.

The present disclosure provides HMDs with adjustable eye relief that may allow the HMDs to fit more comfortably on the face of different users. The HMDs may have an adjustable layer that can be controlled to move further away or closer to the user's face.

In an example, the adjustable layer may be an airbag that allows the adjustable layer to have some flexibility to conform to the unique contours of a user's face. In some examples, the airbag may have independently controllable sections that provide for a more granular, customizable fit for the user. The HMD may have sensors that can detect the contours of the user's face and automatically inflate the airbag in accordance with the contours of the user's face that are detected. Thus, the HMD may be manufactured with a single part (e.g., the adjustable layer) to prevent increased manufacturing costs, while providing an HMD that can be comfortably fit to users with different facial contours.

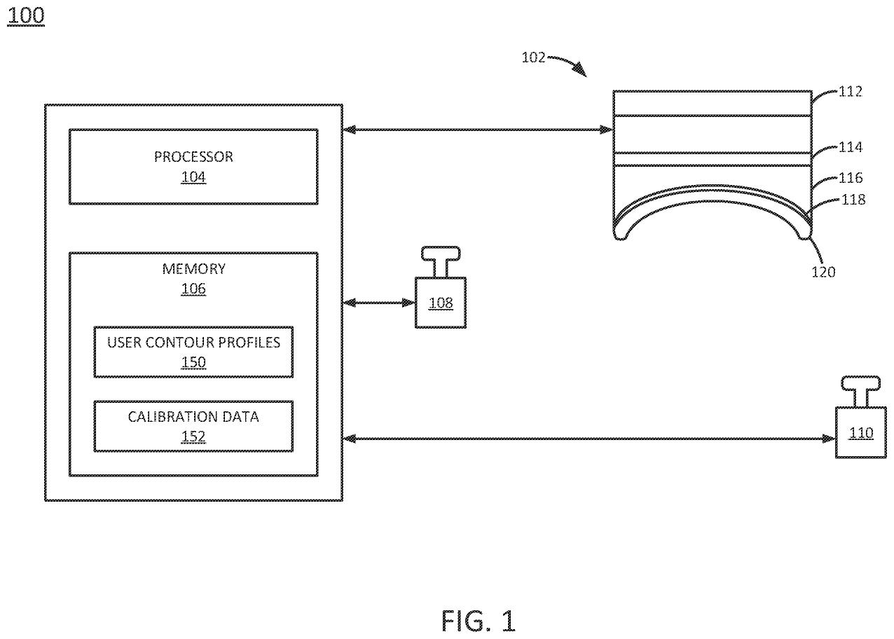

FIG. 1 illustrates an example virtual reality (VR) system 100 of the present disclosure. In an example, the VR system 100 may include a head mounted display (HMD) 102, a processor 104, a memory 106, and controllers 108 and 110. Although the processor 104 and the memory 106 are illustrated as being part of a separate computing device or housing in FIG. 1, it should be noted that the processor 104 and the memory 106 may be located within the HMD 102 as part of an all-in-one or stand-alone VR system 100 that does not use a separate computing device.

The processor 104 may be communicatively coupled to the HMD 102, the memory 106, and the controllers 108 and 110. The processor 104 may load and execute applications (e.g., stored in the memory 106) that are consumed by a user via the HMD 102. For example, the applications may be video games, VR training programs, and the like.

The processor 104 may take interaction inputs from the controllers 108 and 110 and translate the inputs as commands and/or movements that are shown in the HMD 102. For example, the controllers 108 and 110 may be used to move an avatar shown in the HMD 102, interact with items in the VR application, and the like. The controllers 108 and 110 may include haptic feedback to increase the realism of the VR experience.

In an example, the HMD 102 may include a display 112 and a lens 114 within a housing 116 of the HMD 102. The display 112 may present graphics and/or images associated with a VR application executed by the processor 104. The lens 114 may be used to adjust optical properties of the display 112. For example, the lens 114 may be a Fresnel lens. The lens 114 may help to adjust the perceived depth of images viewed on the display 112.

Although example components for the HMD 102 are illustrated in FIG. 1, it should be noted that the HMD 102 may include other components that are not shown. For example, the HMD 102 may include a microphone, speakers, additional input/output interfaces, and the like.

In an example, the HMD 102 may also include an adjustable layer 118 and a foam layer 120. The adjustable layer 118 may allow the eye relief of the HMD 102 to be adjusted for different users. For example, the processor 104 may control dimensions of the adjustable layer 118 to match the facial contours of a user. Said another way, the adjustable layer 118 may increase or decrease a distance of the front surface of the display 112 from the eyes of a user.

The foam layer 120 may provide a more comfortable fit and may prevent components within the adjustable layer 118 from being felt by the face of the user and possibly leading to discomfort. The foam layer 120 may also provide a flexible material to help form fit to the contours of the face of the user as the adjustable layer 118 is adjusted.

As noted above, different users who wear the HMD 102 may have different facial contours or may want different amounts of eye relief to maximize the field of view. For example, some users may wear glasses and need more eye relief to comfortably view the display 112 and to make room within the HMD 102 for the user's glasses. The adjustable layer 118 may be adjusted to increase the eye relief by increasing a width or size of the adjustable layer 118. For example, increasing the width of the adjustable layer 118 may increase a distance between a user's eyes and the display 112.

In an example, the adjustable layer 118 may be adjusted based on user contour profiles 150 that are stored in the memory 106. The user contour profiles 150 may include facial contours of different users and the associated settings for the adjustable layer 118. The settings associated with the facial contours of a user stored in the user contour profiles 150 may be used to control the dimensions of the adjustable layer 118. The settings may indicate how wide the adjustable layer 118 should be adjusted to, or how much air should be delivered to the adjustable layer 118 in the example of an adjustable layer 118 that includes an airbag. For example, the facial contours of different users may be measured and stored in the memory 106. The user contour profiles 150 may be uploaded from an external memory or device that is used to measure the facial contours of a user. In another example, the user contour profiles 150 may be measured using a sensor on the HMD 102, as illustrated in FIG. 7, and discussed in further details below.

When a user logs into the VR system 100, the facial contours may be loaded from the user contour profiles 150 stored in the memory 106. The processor 104 may adjust the adjustable layer 118 in accordance with the facial contours of the user who is logged into the VR system 100. In another example, the facial contours of the user may be measured using a sensor, as discussed in further details below and illustrated in FIG. 7.

In an example, the adjustable layer 118 may be a mechanically adjustable layer. For example, the adjustable layer 118 may include mechanical devices that can expand or contract under the control of the processor 104. The mechanical devices may be small piston like devices, sliding devices, or any other electro-mechanical devices that can be controlled to allow the adjustable layer 118 to expand and/or contract.

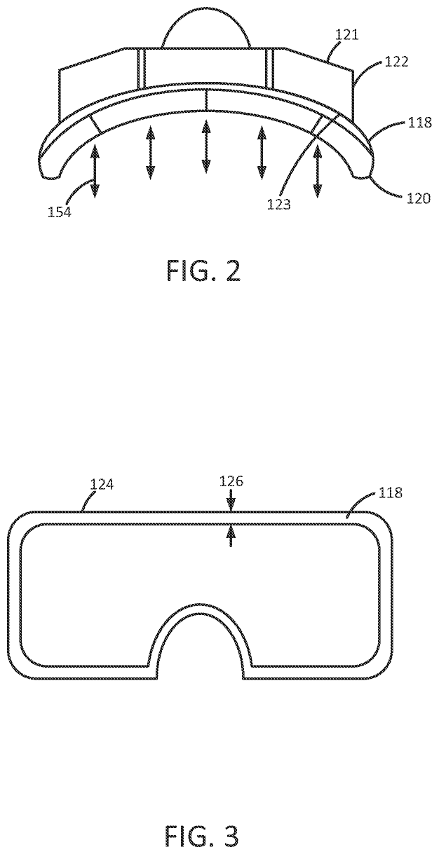

In an example, the adjustable layer 118 may be an airbag. The airbag may be inflated and/or deflated to match the facial contours of the user. A pump may be located inside of the HMD and connected to the airbag to inflate the airbag. The pump may also be used to remove air to deflate the airbag. In an example, the airbag may include a mechanism to manually deflate the airbag. Examples of the airbag are illustrated in FIGS. 2-7 and discussed in further details below.

In an example, the memory 106 may also store calibration data 152. The calibration data 152 may include information related to a conversion of an amount of movement per electrical control or an amount of movement per amount of air inserted into the adjustable layer 118. Thus, the processor 104 may use the calibration data 152 to execute a precise adjustment of the adjustable layer 118. For example, when the adjustable layer 118 is an airbag, the calibration data 152 may allow the processor 104 to know how many cubic feet per minute (cfm) of air flow are used to move the airbag by a desired amount).

In another example, the calibration data 152 may be based on the microfluidic pump in the HMD 102. The pump may be rated to deliver a certain cfm of air during operation. The calibration data 152 may allow the processor 104 to know how long to activate the pump to achieve a desired increase in width of the airbag when adjusting the adjustable layer 118.

FIGS. 2-7 illustrate different examples of the adjustable layer 118 that can be deployed in the HMD 102. FIG. 2 illustrates a top view of a portion of the HMD 102 with adjustable eye relief of the present disclosure. The example illustrated in FIG. 2 illustrates an example where the adjustable layer 118 may be an airbag. The adjustable layer 118 may be coupled to an outer perimeter of an eye mount 122. As the adjustable layer 118 is manipulated, the adjustable layer 118 may move the foam layer 120 towards or away from the display 112 as shown by arrows 154.

The eye mount 122 may provide a base to couple to the housing 116 of the HMD 102 and the adjustable layer 118. The eye mount 122 may be fabricated from plastic to provide support for the adjustable layer 118 on the housing 116 of the HMD 102. A first side 121 of the eye mount 122 may be inserted into the housing 116 and coupled to the housing 116 of the HMD 102. A second side 123 may be coupled to the adjustable layer 118.

FIG. 3 illustrates an example bottom view of the portion of the HMD 102. FIG. 3 illustrates how the adjustable layer 118 is located around an outer perimeter 124 of the eye mount 122 in the HMD 102. For example, the adjustable layer 118 may be formed on the outer perimeter 124 to outline the shape of the eye mount 122. Said another way, the adjustable layer 118 may be formed to match a shape of the outer edge of the eye mount 122. The adjustable layer 118 may have a width 126 that is relatively small (e.g., a few millimeters to a few centimeters).

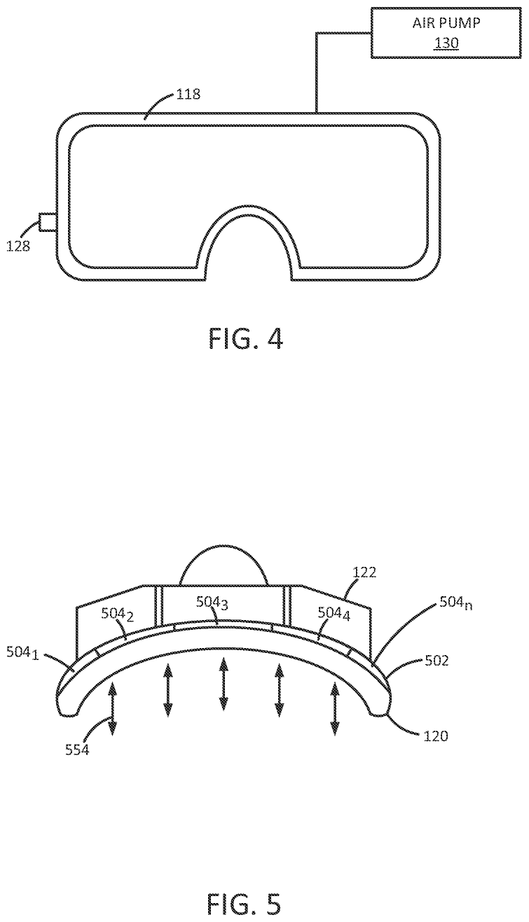

FIG. 4 illustrates a block diagram of an air bag system that provides adjustable eye relief for the HMD 102 of the present disclosure. In an example where the adjustable layer 118 is an airbag, the adjustable layer 118 may be coupled to an air pump 130. The airbag may be fabricated from rubber or a flexible polymer or plastic. The airbag may be formed as a tube that can be shaped to be located around the outer perimeter 124 of the eye mount 122, as shown in FIG. 3.

In an example, the air pump 130 may be a microfluidic pump that is small enough to fit into the housing 116 of the HMD 102. The air pump 130 may be communicatively coupled to the processor 104 and controlled by the processor 104.

In another example, the air pump 130 may be located external to the HMD 102. The adjustable layer 118 may include a one-way valve or check valve (not shown) between the adjustable layer 118 and the air pump 130. The air pump 130 may be controlled by the processor 104 to inflate the adjustable layer 118 as desired. The air pump 130 may be disconnected from the adjustable layer 118 after the desired amount of air is delivered to the adjustable layer 118. The one-way valve or check valve may keep the adjustable layer 118 inflated to the desired level and may prevent the air from escaping the adjustable layer 118.

In an example, when the processor 104 activates the air pump 130, air may be delivered to the adjustable layer 118 to inflate the adjustable layer 118. The amount of air that is delivered may be based on the user contour profiles 150 and the calibration data 152.

In an example, the air pump 130 may also be used to deflate the adjustable layer 118. For example, the air pump 130 may draw the air out of the adjustable layer 118 to return the adjustable layer 118 to a default position ready to be fit to the facial contours of another user. For example, the default position may be a position where the adjustable layer 118 is at a minimum width, deflated to remove all the air, or a position that moves the foam layer at a minimum distance towards the display 112 (e.g., a closest position to the display 112).

In an example, the adjustable layer 118 may include a valve 128. The valve 128 may be an air release valve to allow for manual removal of air from the adjustable layer 118 to return the adjustable layer 118 to the default position. For example, pressing the valve 128 may allow air to escape from the adjustable layer 118.

FIG. 5 illustrates another example portion of the HMD 102 with adjustable eye relief of the present disclosure. FIG. 5 illustrates an example of the adjustable layer 118 that includes an airbag 502 with a plurality of independently inflatable sections 504₁ to 504ₙ (hereinafter also referred to individually as an inflatable section 504 or collectively referred to as inflatable sections 504). In other words, each inflatable section 504 may be inflatable with different amounts of air.

The airbag 502 may allow the foam layer 120 to be moved towards or away from the display 112 as shown by arrows 554. The inflatable sections 504 may provide more granular control of the adjustable layer 118 and may allow for a more custom fit of the HMD 102 to the facial contour of a user.

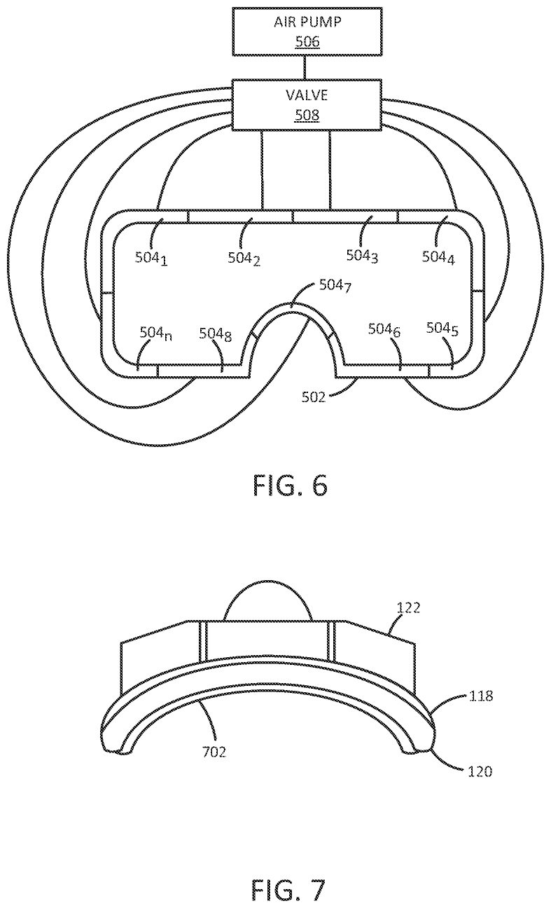

FIG. 6 illustrates an example air bag system for the airbag 502 with the plurality of independently inflatable sections 504 of the present disclosure. In an example, an air pump 506 may be coupled to a valve 508. The valve 508 may be coupled to each one of the inflatable sections 504.

For example, the air pump 506 may be a microfluidic pump similar to the air pump 130 illustrated in FIG. 4 and described above. In another example, the air pump 506 may be located externally from the HMD 102, but removably connected to the airbag 502 via a one-way valve or a check valve (not shown).

The valve 508 may be a multi-channel electro-mechanical valve. In other words, the valve 508 may include electrically controllable mechanical channels to direct air into a desired inflatable section 504 of the airbag 502. Each one of the inflatable sections 504 may be coupled to one of the channels in the valve 508. For example, the inflatable section 504₁ may be coupled to a first channel of the valve 508, the inflatable section 504₂ may be coupled to a second channel of the valve 508, and so forth, up to the inflatable section 504ₙ being connected to an nth channel of the valve 508.

The processor 104 may inflate each inflatable section 504 independently by controlling which channel of the valve 508 is opened. For example, to inflate the inflatable section 504₁, the processor 104 may open a first channel of the valve 508 and activate the air pump 506. The inflatable section 504₁ may be inflated to a desired amount. The first channel may be closed and the air pump 506 may be deactivated. The process may be repeated for each one of the remaining independently inflatable sections 504₂ to 504ₙ as desired based on the facial contours of the user.

By independently controlling each inflatable section 504, the HMD 102 may provide a more custom fit for different facial contours of different users. For example, some users may use more adjustment around the outer edges by the user's cheekbones (e.g., the inflatable sections 504₅ and 504ₙ). Some users may have a smaller nose bridge and use more adjustment by the user's nose (e.g., the inflatable section 504₇). The independently inflatable sections 504 may be strategically deployed and/or divided based on where more granular adjustments may be used. For example, the independently inflatable sections 504 may be located around the orbital bone of the eye, the bridge of the nose, cheek bones of the face, and so forth.

FIG. 7 illustrates a block diagram of another example portion of the HMD with adjustable eye relief of the present disclosure. In an example, the adjustable layer 118 may be coupled to the eye support 122 and the foam layer 120, as described above. In an example, a sensor 702 may be located on the foam layer 120 opposite the adjustable layer 118. For example, the sensor 702 may be coupled to the foam layer 120 such that the sensor 702 may contact the face of a user.

In an example, the sensor 702 may detect and/or measure the facial contours of the user. The sensor 702 may be a thin film capacitive sensor that can detect a change in resistance when contacting the skin of the user. When the HMD 102 is worn, the sensor 702 may detect which portions of the sensor 702 are not in contact with the skin of the user based on different resistive readings at different locations around the sensor 702.

The different readings may be used to map the locations of the user's face that do not contact the foam layer 120. For example, an origin of the sensor 702 may be located at a center top of the sensor 702. Different locations of the sensor 702 may be associated with different locations along the sensor 702, moving from the origin at the top center of the sensor 702 and moving clockwise tracing the outer perimeter of the eye support 122, and back around to the origin.

Based on the facial contour that is mapped by the sensor 702, the adjustable layer 118 may be inflated (e.g., in the example of an airbag) to a desired amount based on the facial contour that is mapped. In an example, the adjustable layer 118 may include the airbag 502 with the independently inflatable sections 504 illustrated in FIGS. 5 and 6. The appropriate inflatable sections 504 may be inflated based on the locations of the user's face that do not contact the sensor 702 in accordance with the facial contour that is mapped.

In an example, the sensor 702 may remain active while the adjustable layer 118 is being manipulated. When the face of the user contacts the entire sensor 702, adjustment of the adjustable layer 118 may be stopped. Thus, the sensor 702 may provide real-time feedback to the processor 104 as the adjustable layer 118 is being controlled.

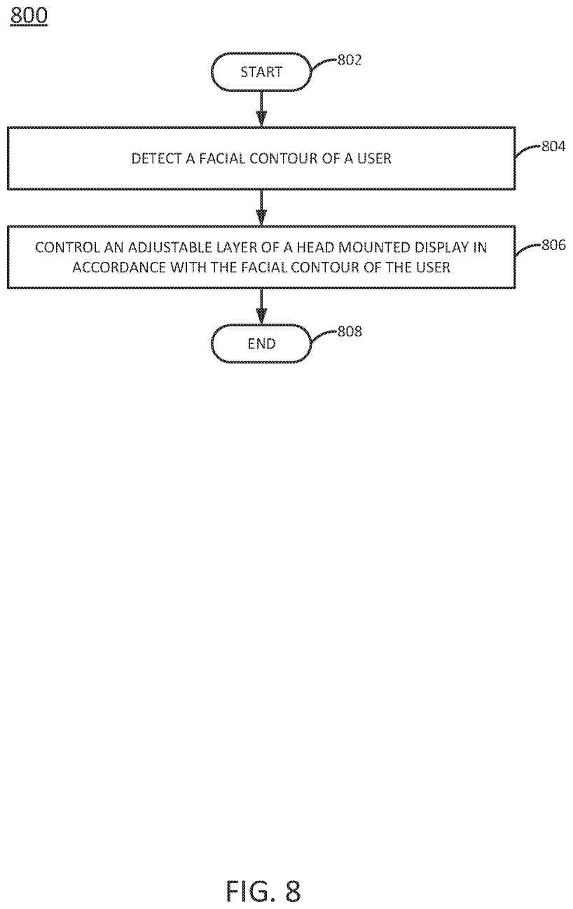

FIG. 8 illustrates a flow diagram of an example method 800 for adjusting eye relief of an HMD of the present disclosure. In an example, the method 800 may be performed by the VR system 100 illustrated in FIG. 1.

At block 802, the method 800 begins. At block 804, the method 800 detects a facial contour of a user. For example, the facial contours of different users may be stored in a memory of the VR system. When a user logs into the VR system, the facial contour associated with the user may be loaded from the memory to adjust the eye relief of the HMD.

In another example, the facial contour of the user may be measured. For example, the HMD may include a sensor (e.g., a capacitive sensor) that can detect contact with the user's face. The sensor may be located around an outer perimeter of the HMD. The sensor may detect portions of the sensor that do not contact the skin on the face of the user. The locations on the sensor associated with the portions that do not detect facial contact may be mapped to determine which areas may implement additional eye relief adjustment in the HMD.

At block 806 the method 800 controls an adjustable layer of a head mounted display in accordance with the facial contour of the user. For example, the adjustable layer may be moved such that the user has a sufficient amount of eye relief and such that the HMD rests comfortably on the face of the user.

In an example, the adjustable layer may be a mechanical adjustment mechanism. For example, the adjustable layer may include a movable mechanism that can increase a width of the adjustable layer. The movable mechanism or mechanisms can be controlled electronically via a processor of the VR system.

In another example, the adjustable layer may be an airbag. The airbag may be inflated and/or deflated to match the facial contour of the user. For example, an air pump controlled by a processor of the VR system may be activated to inflate the adjustable layer until the capacitive sensor indicates that the adjustable layer matches the facial contour of the user. In other words, the adjustable layer may be adjusted to contact all portions of the face of the user.

In an example, the airbag may have multiple independently inflatable sections to provide more granular control. As a result, the adjustable layer may provide a more custom fit for different facial contours of different users. At block 806, the method 800 ends.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An apparatus, comprising:
an eye mount, wherein a first side of the eye mount is to be coupled to a display portion of a head mounted display;
an adjustable layer coupled to an outer perimeter of a second side of the eye mount; and
a foam layer coupled to the adjustable layer.

2. The apparatus of claim 1, further comprising:
a processor communicatively coupled to the adjustable layer to control a dimension of the adjustable layer.

3. The apparatus of claim 1, further comprising:
a memory communicatively coupled to the processor to store settings for the adjustable layer for different user profiles, wherein the processor is to control the dimensions of the adjustable layer based on a user profile of the different user profiles that is loaded.

4. The apparatus of claim 1, wherein the adjustable layer comprises a mechanically adjustable layer.

5. The apparatus of claim 1, wherein the adjustable layer comprises an airbag.

6. The apparatus of claim 5, wherein the airbag comprises a valve to release air inside of the airbag and return the airbag to a default position.

7. An apparatus, comprising:
an eye mount, wherein a first side of the eye mount is to be coupled to a display portion of a head mounted display;
an airbag layer coupled to an outer perimeter of a second side of the eye mount, wherein the airbag layer comprises a plurality of independently inflatable sections; and
a foam layer coupled to the airbag layer.

8. The apparatus of claim 7, further comprising:
a sensor coupled to the foam layer to detect facial contours of a user.

9. The apparatus of claim 8, further comprising:
a processor communicatively coupled to the sensor, wherein the processor is to control an amount of air provided to each one of the plurality of independently inflatable sections based on the facial contours of the user detected by the sensor.

10. The apparatus of claim 8, wherein the sensor comprises a capacitive sensor.

11. The apparatus of claim 7, further comprising:
an air pump coupled to the airbag layer; and
a multi-channel valve coupled to the air pump and to the plurality of independently inflatable sections of the airbag layer.

12. A method, comprising:
detecting, by a processor of a head mounted display (HMD), a facial contour of a user; and
controlling, by the processor, an adjustable layer of the head mounted display in accordance with the facial contour of the user.

13. The method of claim 12, wherein the detecting is based on a user profile stored in a memory that is loaded into the HMD.

14. The method of claim 12, wherein the detecting comprises:
receiving, by the processor, data from a capacitive sensor indicating portions of the capacitive sensor that do not contact a face of the user.

15. The method of claim 14, wherein the controlling comprises:
activating, by the processor, an air pump to inflate the adjustable layer until the capacitive sensor indicates that the adjustable layer matches the facial contour of the user.
